(19) United States
(12) Patent Application Publication
(10) Pub. No.: US 2026/0049900 A1
(43) Pub. Date: Feb. 19, 2026

(54) ASSESSING THE HEALTH OF A PRODUCTION FACILITY

(71) Applicant: Schlumberger Technology Corporation, Sugar Land, TX (US)

(72) Inventors: Rahul Kumar, Pune (IN); Swapnil Dubey, Pune (IN); Neha Agrawal, Pune (IN)

(21) Appl. No.: 19/227,602

(22) Filed: Jun. 4, 2025

(30) Foreign Application Priority Data
Jun. 26, 2024 (IN) 202411049093

(51) Int. Cl. G01M 99/00; G06N 20/00

(52) U.S. Cl. CPC G01M 99/00; G06N 20/00

(57) ABSTRACT

A method for determining a health of a production facility includes receiving first input data including (1) physical properties of components within the production facility at a plurality of different times and (2) the health of the production facility at the different times. The method also includes training a machine-learning (ML) model based upon the first input data to produce a trained ML model. The method also includes receiving second input data. The second input data is measured and/or received after the ML model is trained. The second input data includes the physical properties of the components within the production facility. The method also includes determining the health of the production facility using the trained ML model based upon the second input data.

### CROSS-REFERENCE TO RELATED APPLICATIONS

This application claims priority to India Provisional Patent Application No. 202411049093, filed on Jun. 26, 2024, which is incorporated by reference.

### BACKGROUND

Knowledge of the health of a facility should be available at any given time. Conventional models generally provide the health of individual components in the facility, but not the overall health of the facility. These components may or may not have an impact on the overall facility's health. Therefore, what is needed is an improved system and method for determining or assessing the overall health of a production facility.

### SUMMARY

A method for determining a health of a production facility is disclosed. The method includes receiving first input data including (1) physical properties of components within the production facility at a plurality of different times and (2) the health of the production facility at the different times. The method also includes training a machine-learning (ML) model based upon the first input data to produce a trained ML model. The method also includes receiving second input data. The second input data is measured and/or received after the ML model is trained. The second input data includes the physical properties of the components within the production facility. The method also includes determining the health of the production facility using the trained ML model based upon the second input data.

A computing system is also disclosed. The computing system includes one or more processors and a memory system. The memory system includes one or more non-transitory computer-readable media storing instructions that, when executed by at least one of the one or more processors, cause the computing system to perform operations. The operations include receiving first input data. The first input data includes physical properties of components within the production facility at a plurality of different times. The physical properties include pressure, temperature, liquid flow rate, vibration speed, or a combination thereof. The components include one or more pumps, compressors, motors, desalters, dehydrators, filters, membranes, valves, or a combination thereof. The physical properties are measured by one or more sensors. The first input data also includes the health of the production facility at the different times. The health of the production facility is determined based upon the physical properties of the components. The health of the production facility is determined by a user that is a subject matter expert (SME) for the production facility. The health of the facility selected from a plurality of different levels, and wherein the different levels comprise good, bad, and critical. The operations also include training a machine-learning (ML) model based upon the first input data to produce a trained ML model. The operations also include receiving second input data. The second input data is measured and/or received after the ML model is trained. The second input data includes the physical properties of the components within the production facility. The components in the second input data include the same components in the first input data or different components. The production facility represented by the second input data includes the same production facility represented by the first input data or a different production facility. The operations also include determining the health of the production facility using the trained ML model based upon the second input data. The health is determined based upon equations corresponding to a health of the respective components and weights corresponding to the respective components. One or more of the equations has an order greater than two. The weights represent contributions or criticalities of the respective components to the health of the production facility.

A non-transitory computer-readable medium is also disclosed. The medium stores instructions that, when executed by one or more processors of a computing system, cause the computing system to perform operations. The operations include receiving first input data. The first input data includes physical properties of components within the production facility at a plurality of different times. The physical properties include pressure, temperature, liquid flow rate, vibration speed, or a combination thereof. The components include one or more pumps, compressors, motors, desalters, dehydrators, filters, membranes, valves, or a combination thereof, and wherein the physical properties are measured by one or more sensors. The first input data also includes the health of the production facility at the different times. The health of the production facility is determined based upon the physical properties of the components. The health of the production facility is determined by a user that is a subject matter expert (SME) for the production facility. The health of the facility selected from a plurality of different levels. The different levels include good, bad, and critical. The operations also include training a machine-learning (ML) model based upon the first input data to produce a trained ML model. The operations also include receiving second input data. The second input data is measured and/or received after the ML model is trained. The second input data includes the physical properties of the components within the production facility. The components in the second input data comprise the same components in the first input data or different components. The production facility represented by the second input data comprises the same production facility represented by the first input data or a different production facility. The operations also include determining the health of the production facility using the trained ML model based upon the second input data. The health is determined based upon: health=w₁c₁+w₂c₂+w₃c₃+ . . . +wₙcₙ where c₁, c₂, . . . cₙ represent equations corresponding to a health of the respective components and w₁, w₂, . . . wₙ represent weights corresponding to the respective components. One or more of the equations has an order greater than two. The order is between two and three or between three and four. The weights represent contributions or criticalities of the respective components to the health of the production facility. One of the equations that corresponds to a first of the components comprises: c₁=p₁^{a}+p₂^{b}+ . . . N where p₁ represents a first of the physical properties of the first component, p₂ represents a second of the physical properties of the first component, a represents a first exponent, b represents a second exponent, and N represents a numerical constant. The first and/or second exponents have the order greater than two. The order and the numerical constant are determined by the trained ML model.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates a flowchart of a method for determining a health of a production facility, according to an embodiment.

FIG. 3 illustrates a diagram that represents the end-to-end flow for determining the health of the production facility, according to an embodiment.

FIG. 4 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

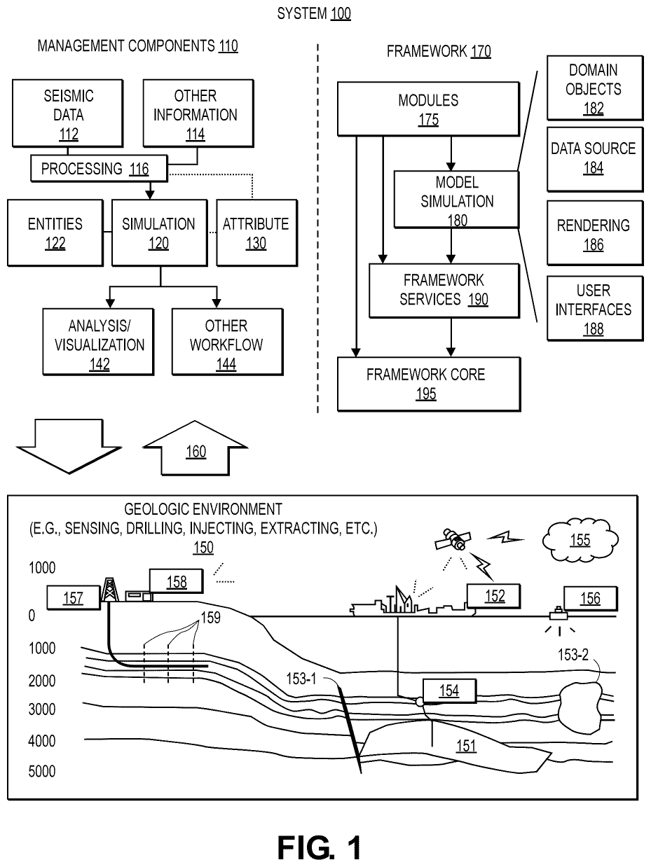

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

### Assessing the Health of a Production Facility

A facility may separate oil, gas, water, and/or solids from a fluid that is produced from a wellbore. The facility may also treat the oil to meet the standards that are agreed upon between the upstream companies and downstream organizations. The facility may contain equipment such as compressors, pumps, motors, membranes, desalters, filters, etc. that are high in cost. In some embodiments, almost 70% of the facility setup investment goes into this equipment. The health of the facility can be determined by the health of different pieces of equipment which further depends upon properties such as pressure, temperature, BSW, etc.

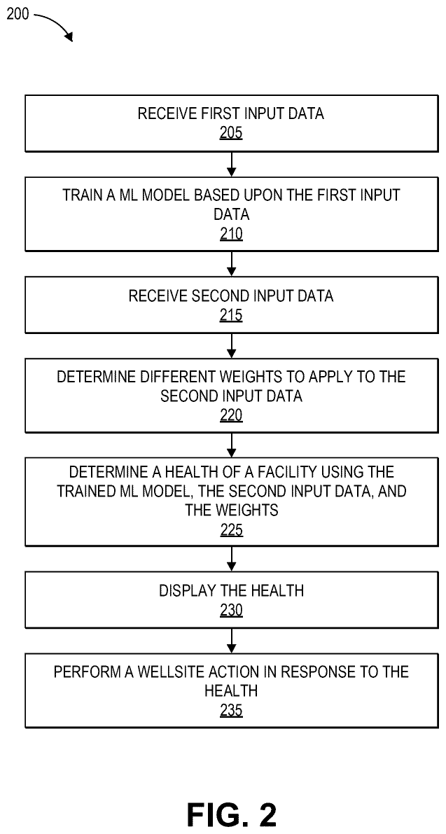

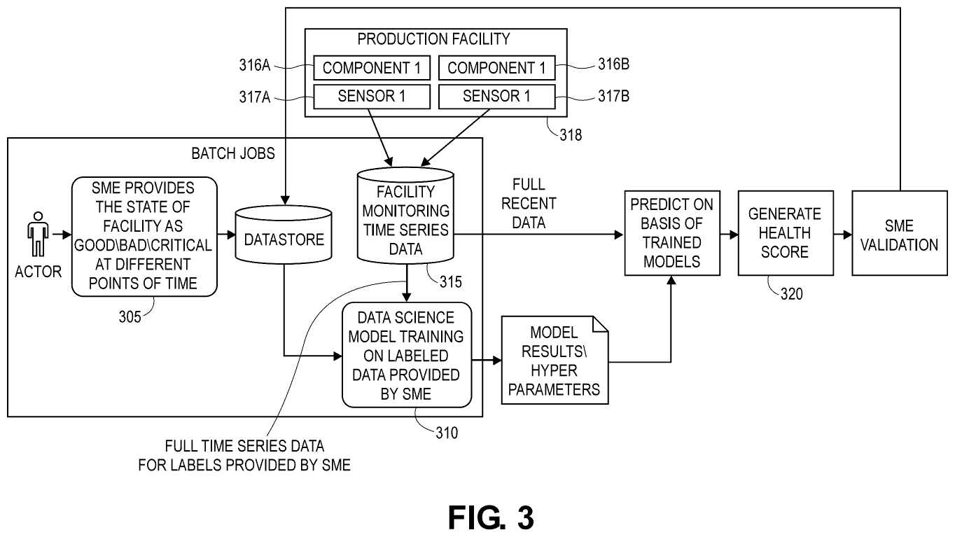

FIG. 2 illustrates a flowchart of a method for determining a health of a production facility 318, according to an embodiment. An illustrative order of the method 200 is provided below; however, one or more portions of the method 200 may be performed in a different order, simultaneously, repeated, or omitted. At least a portion of the method 200 may be performed by a computing system (described below). FIG. 3 illustrates a diagram that shows the end-to-end flow for determining the health of the facility 318, according to an embodiment.

The method 200 may include receiving first input data, as at 205. An example of this is also shown at 305 in FIG. 3. The first input data may include physical properties of components 316A, 316B within the production facility 318 at a plurality of different times. The physical properties may be or include pressure, temperature, liquid flow rate, vibration speed, or a combination thereof. The components 316A, 316B may be or include one or more pumps, compressors, motors, desalters, filters, membranes, valves, or a combination thereof. The physical properties may be measured by one or more sensors 317A, 317B. The measured physical properties may be pushed to monitoring applications. These monitoring applications save the sensor values in a time-series format.

The first input data may also or instead include the health of the production facility 318 at the different times. The health may be determined by a first user that is a subject matter expert (SME) for the production facility 318. The health of the facility 318 may be selected from a plurality of different levels. In an example, the different levels may include good, bad, and/or critical. For example, the SME can define the state of the facility 318 (e.g., good, bad, and/or critical), and these observations combined with the sensor values can be used to predict the current health of the facility 318, as described below.

The method 200 may also include training a machine-learning (ML) model based upon the first input data to produce a trained ML model, as at 210. An example of this is also shown at 310 in FIG. 3. More particularly, the ML model may be created and/or trained based upon the first input data. The ML model may run on a clustering family of data science, which categorizes a facility 318 with the states (e.g., good, bad, and/or critical). The model may be trained using the sensor values and/or health-related data that the SME provides.

The method 200 may also include receiving second input data, as at 215. An example of this is also shown at 315 in FIG. 3. The second input data may be received after the ML model is trained. The second input data may be or include the physical properties of the components 316A, 316B within the production facility 318. The components 316A, 316B in the second input data may be or include the same components in the first input data or different components. In one example, the components 316A, 316B in the first input data may be or include a compressor and a desalter, respectively, and the components in the second input data may be a different compressor and a different desalter. In another example, the components 316A, 316B in the first input data may be or include a compressor and a desalter, respectively, and the components in the second input data may be a pump and a motor. The production facility represented by the second input data comprises the same production facility represented by the first input data or a different production facility.

The method 200 may also include determining the health of the production facility 318, as at 220. An example of this is also shown at 320 in FIG. 3. The health may be determined using the trained ML model. The health may be determined based upon the second input data. In an example, the health of the production facility 318 may be determined based upon:

$$health = {w}_{1} {c}_{1} + {w}_{2} {c}_{2} + {w}_{3} {c}_{3} + … + {w}_{n} {c}_{n} \qquad ( 1 )$$

where c₁, c₂, . . . cₙ represent equations corresponding to a health of the respective components 316A, 316B and w₁, w₂, . . . wₙ represent weights corresponding to the respective components 316A, 316B. One or more of the equations has an order greater than two. In an example:

$${c}_{1} = {p}_{1}^{2} + {p}_{2}^{3} + … N \qquad ( 2 )$$

where p₁ represents a first of the physical properties (e.g., pressure) of a first of the components 316A, p₂ represents a second of the physical properties (e.g., temperature) of the first component 316A, and N represents a numerical constant.

In a more specific example where the components include three dehydrators (e.g., sharing an equal load of crude oil):

$${c}_{1} = {p}_{1}^{3.67} + {p}_{2}^{2.15} + {p}_{3}^{0.5} + 1.175 \qquad ( 3 )$$

where c₁ represents a first of the dehydrators, p₁ represents temperature, p₂ represents pressure, and p₃ represents the operating duration. The order/exponents (e.g., 3.67, 2.15, and/or 0.5) may be determined by the trained ML model or a different model. The numerical constant (e.g., 1.175) is determined based upon the trained ML model or a different model. Then, the health of the production facility 318 may be determined based upon:

$$health = ( 1 / 3 ) ⋆ {c}_{1} + ( 1 / 3 ) ⋆ {c}_{2} + ( 1 / 3 ) ⋆ {c}_{3} \qquad ( 4 )$$

The weights in equation (4) may vary based upon the arrangement of the components (e.g., dehydrators) and/or the volume of crude oil flowing through each dehydrator. The variables c₁, c₂, and c₃ represent the health of each of the dehydrators.

The weights may represent contributions of the respective components 316A, 316B to the health of the production facility 318. For example, a midstream facility can have multiple compressors, along with other components such as desalters, valves, and more, that are installed in a specific arrangement. In this setup, the contribution of one compressor may be more relevant (e.g., critical) than that of another. A more relevant compressor, when failing to perform at a certain level, can impact the overall efficiency of the facility. Conversely, a less relevant compressor may have a more minimal effect. If the health of the more relevant compressor deteriorates, it may lead to a complete shutdown of the facility's operations. Therefore, the weight assigned to the properties of the more relevant compressor may be higher compared to those assigned to less relevant components, reflecting their varying levels of impact on facility performance.

Once the model is trained, with further incoming data, the model may start identifying the weightage of the component data and/or determining the health of the facility accordingly. This may be further validated by the SME. This may allow periodic training to also take place for the model. Periodic training may help the model to yield a more accurate result.

The method 200 may also include displaying the health of the production facility 318, as at 225.

The method 200 may also include performing an action in response to the health of the production facility 318, as at 230. The action may be or include generating and/or transmitting a signal (e.g., using a computing system) that recommends, instructs, and/or causes a physical action to occur at the facility (e.g., a midstream production facility) 318. The action may also or instead include performing the physical action at the facility 318. The physical action may include repairing or replacing one or more of the components 316A, 316B. For example, the physical action may include repairing or replacing the first component 316A in response to the health of the first component 316A being less than a predetermined health threshold and/or the contribution or criticality of the first component 316A being greater than a predetermined contribution or criticality threshold.

The method generates a unique ML model to determine the weightage of different components to provide a score to determine the overall health of the facility. The method may also help to determine the facility's health optimally without human intervention and in near real-time.

### Exemplary Computing System

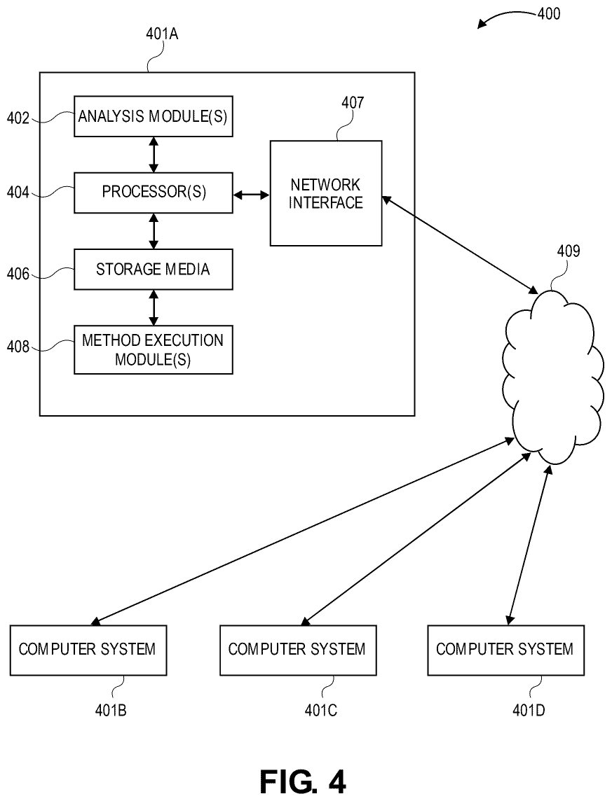

In some embodiments, the methods of the present disclosure may be executed by a computing system. FIG. 4 illustrates an example of such a computing system 400, in accordance with some embodiments. The computing system 400 may include a computer or computer system 401A, which may be an individual computer system 401A or an arrangement of distributed computer systems. The computer system 401A includes one or more analysis modules 402 that are configured to perform various tasks according to some embodiments, such as one or more methods disclosed herein. To perform these various tasks, the analysis module 402 executes independently, or in coordination with, one or more processors 404, which is (or are) connected to one or more storage media 406. The processor(s) 404 is (or are) also connected to a network interface 407 to allow the computer system 401A to communicate over a data network 409 with one or more additional computer systems and/or computing systems, such as 401B, 401C, and/or 401D (note that computer systems 401B, 401C and/or 401D may or may not share the same architecture as computer system 401A, and may be located in different physical locations, e.g., computer systems 401A and 401B may be located in a processing facility, while in communication with one or more computer systems such as 401C and/or 401D that are located in one or more data centers, and/or located in varying countries on different continents).

A processor may include a microprocessor, microcontroller, processor module or subsystem, programmable integrated circuit, programmable gate array, or another control or computing device.

The storage media 406 may be implemented as one or more computer-readable or machine-readable storage media. Note that while in the example embodiment of FIG. 4 storage media 406 is depicted as within computer system 401A, in some embodiments, storage media 406 may be distributed within and/or across multiple internal and/or external enclosures of computing system 401A and/or additional computing systems. Storage media 406 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 400 contains one or more method execution module(s) 408. In the example of computing system 400, computer system 401A includes the method execution module 408. In some embodiments, a single method execution module may be used to perform some aspects of one or more embodiments of the methods disclosed herein. In other embodiments, a plurality of method execution modules may be used to perform some aspects of methods herein.

It should be appreciated that computing system 400 is merely one example of a computing system, and that computing system 400 may have more or fewer components than shown, may combine additional components not depicted in the example embodiment of FIG. 4, and/or computing system 400 may have a different configuration or arrangement of the components depicted in FIG. 4. The various components shown in FIG. 4 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 400, FIG. 4), and/or through manual control by a user who may make determinations regarding whether a given step, action, template, model, or set of curves has become sufficiently accurate for the evaluation of the subsurface three-dimensional geologic formation under consideration.

The foregoing description, for purposes of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for determining a health of a production facility, the method comprising:
receiving first input data comprising:
physical properties of components within the production facility at a plurality of different times; and
the health of the production facility at the different times;
training a machine-learning (ML) model based upon the first input data to produce a trained ML model;
receiving second input data, wherein the second input data is measured and/or received after the ML model is trained, and wherein the second input data comprises the physical properties of the components within the production facility; and
determining the health of the production facility using the trained ML model based upon the second input data.

2. The method of claim 1, wherein the physical properties comprise pressure, temperature, liquid flow rate, vibration speed, or a combination thereof, and wherein the physical properties are measured by one or more sensors.

3. The method of claim 1, wherein the components comprise one or more pumps, compressors, motors, desalters, dehydrators, filters, membranes, valves, or a combination thereof.

4. The method of claim 1, wherein the health of the production facility is determined based upon the physical properties of the components, and wherein the health of the production facility is determined by a user.

5. The method of claim 1, wherein the components in the second input data are different than the components in the first input data, and wherein the production facility represented by the second input data is a different production facility than the production facility represented by the first input data.

6. The method of claim 1, wherein the health is determined based upon:
$$health = {w}_{1} {c}_{1} + {w}_{2} {c}_{2} + {w}_{3} {c}_{3} + … + {w}_{n} {c}_{n}$$
where c₁, c₂, . . . cₙ represent equations corresponding to a health of the respective components and w₁, w₂, . . . wₙ represent weights corresponding to the respective components, and wherein the weights represent contributions or criticalities of the respective components to the health of the production facility.

7. The method of claim 6, wherein one or more of the equations has an order greater than two.

8. The method of claim 7, wherein the order is between two and three or between three and four, and wherein the order is determined by the trained ML model.

9. The method of claim 1, further comprising displaying the health of the production facility.

10. The method of claim 1, further comprising performing an action in response to the health of the production facility.

11. A computing system, comprising:
one or more processors; and
a memory system comprising one or more non-transitory computer-readable media storing instructions that, when executed by at least one of the one or more processors, cause the computing system to perform operations, the operations comprising:
receiving first input data, wherein the first input data comprises:
physical properties of components within the production facility at a plurality of different times, wherein the physical properties comprise pressure, temperature, liquid flow rate, vibration speed, or a combination thereof, wherein the components comprise one or more pumps, compressors, motors, desalters, dehydrators, filters, membranes, valves, or a combination thereof, and wherein the physical properties are measured by one or more sensors; and
the health of the production facility at the different times, wherein the health of the production facility is determined based upon the physical properties of the components, wherein the health of the production facility is determined by a user that is a subject matter expert (SME) for the production facility, and wherein the health of the facility selected from a plurality of different levels;
training a machine-learning (ML) model based upon the first input data to produce a trained ML model;
receiving second input data, wherein the second input data is measured and/or received after the ML model is trained, wherein the second input data comprises the physical properties of the components within the production facility, wherein the components in the second input data comprise the same components in the first input data or different components, and wherein the production facility represented by the second input data comprises the same production facility represented by the first input data or a different production facility; and
determining the health of the production facility using the trained ML model based upon the second input data, wherein the health is determined based upon equations corresponding to a health of the respective components and weights corresponding to the respective components, wherein one or more of the equations has an order greater than two, and wherein the weights represent contributions or criticalities of the respective components to the health of the production facility.

12. The computing system of claim 11, wherein numerical constants in the equations are determined by the trained ML model.

13. The computing system of claim 11, wherein the components comprise three dehydrators that share an equal load of crude oil.

14. The computing system of claim 13, wherein the weights are each one third.

15. The computing system of claim 14, wherein one of the equations that corresponds to a first of the dehydrators comprises:
$${c}_{1} = {p}_{1}^{3.67} + {p}_{2}^{2.15} + {p}_{3}^{0.5} + 1.175$$
where c₁ represents the equation corresponding to a health of the first dehydrator, p₁ represents a first of the physical properties of the first dehydrator, p₂ represents a second of the physical properties of the first dehydrator, and p₃ represents a third of the physical properties of the first dehydrator.

16. A non-transitory computer-readable medium storing instructions that, when executed by one or more processors of a computing system, cause the computing system to perform operations, the operations comprising:
receiving first input data, wherein the first input data comprises:
physical properties of components within the production facility at a plurality of different times, wherein the physical properties comprise pressure, temperature, liquid flow rate, vibration speed, or a combination thereof, wherein the components comprise one or more pumps, compressors, motors, desalters, dehydrators, filters, membranes, valves, or a combination thereof, and wherein the physical properties are measured by one or more sensors; and
the health of the production facility at the different times, wherein the health of the production facility is determined based upon the physical properties of the components, wherein the health of the production facility is determined by a user that is a subject matter expert (SME) for the production facility, wherein the health of the facility selected from a plurality of different levels, and wherein the different levels comprise good, bad, and critical;
training a machine-learning (ML) model based upon the first input data to produce a trained ML model;
receiving second input data, wherein the second input data is measured and/or received after the ML model is trained, wherein the second input data comprises the physical properties of the components within the production facility, wherein the components in the second input data comprise the same components in the first input data or different components, and wherein the production facility represented by the second input data comprises the same production facility represented by the first input data or a different production facility; and
determining the health of the production facility using the trained ML model based upon the second input data, wherein the health is determined based upon:
$$health = {w}_{1} {c}_{1} + {w}_{2} {c}_{2} + {w}_{3} {c}_{3} + … + {w}_{n} {c}_{n}$$
where c₁, c₂, . . . cₙ represent equations corresponding to a health of the respective components and w₁, w₂, . . . wₙ represent weights corresponding to the respective components, wherein one or more of the equations has an order greater than two, wherein the order is between two and three or between three and four, wherein the weights represent contributions or criticalities of the respective components to the health of the production facility, wherein one of the equations that corresponds to a first of the components comprises:
$${c}_{1} = {p}_{1}^{a} + {p}_{2}^{b} + … N$$
where p₁ represents a first of the physical properties of the first component, p₂ represents a second of the physical properties of the first component, a represents a first exponent, b represents a second exponent, and N represents a numerical constant, wherein the first and/or second exponents have the order greater than two, and wherein the order and the numerical constant are determined by the trained ML model.

17. The non-transitory computer-readable medium of claim 16, wherein the operations further comprise displaying the health of the production facility.

18. The non-transitory computer-readable medium of claim 16, wherein the operations further comprise performing an action in response to the health of the production facility.

19. The non-transitory computer-readable medium of claim 18, wherein the action comprises generating and/or transmitting a signal that recommends, instructs, and/or causes a physical action to occur at the production facility.

20. The non-transitory computer-readable medium of claim 19, wherein the physical action comprises repairing or replacing the first component in response to the health of the first component being less than a predetermined health threshold and the contribution or criticality of the first component being greater than a predetermined contribution or criticality threshold.
